(19) United States
(12) Patent Application Publication
(10) Pub. No.: US 2026/0281886 A1
(43) Pub. Date: Sep. 17, 2026

(54) METHODS FOR TIERED RADIO RESOURCE MANAGEMENT AND MOBILITY MANAGEMENT IN MOBILE COMMUNICATIONS

(71) Applicant: MEDIATEK INC., Hsinchu City (TW)

(72) Inventors: Din-Hwa HUANG, Hsinchu City (TW); Chia-Hao YU, Hsinchu City (TW); Jiann-Ching GUEY, Hsinchu City (TW)

(21) Appl. No.: 19/472,698

(22) PCT Filed: Aug. 29, 2024
(86) PCT No.: PCT/CN2024/115456

§ 371 Date: Oct. 5, 2025

Related U.S. Application Data
(60) Provisional application No. 63/582,554, filed on Sep. 14, 2023.
(60) Provisional application No. 63/582,552, filed on Sep. 14, 2023.

(51) Int. Cl. H04W 48/18; H04W 74/0833

(52) U.S. Cl. CPC H04W 48/18; H04W 74/0833

(57) ABSTRACT

Various solutions for tiered radio resource management (RRM) and mobility management are described. An apparatus may receive a first reference signal (RS) from a coverage area. The first RS may include identification information of the coverage area. The apparatus may receive a respective second RS from each of a plurality of network nodes within the coverage area. The second RS each may include identification information of a respective one of the plurality of network nodes. Then, the apparatus may perform a first measurement based on the first RS to determine whether to switch a service link from the coverage area to another coverage area, and perform a second measurement based on the second RS to select one or more network nodes from a network node set to form the service link, wherein the network node set includes at least the plurality of network nodes.

### CROSS REFERENCE TO RELATED PATENT APPLICATION(S)

The present disclosure is part of a non-provisional application claiming the priority benefit of U.S. Patent Application No. 63/582,554, filed 14 Sep. 2023, and U.S. Patent Application No. 63/582,552, filed 14 Sep. 2023. The contents of aforementioned applications are herein incorporated by reference in their entirety.

### TECHNICAL FIELD

The present disclosure is generally related to mobile communications and, more particularly, to tiered radio resource management (RRM) and mobility management with respect to user equipment (UE) and network node in mobile communications.

### BACKGROUND

Unless otherwise indicated herein, approaches described in this section are not prior art to the claims listed below and are not admitted as prior art by inclusion in this section.

For current network implementations, one base station (BS) is operable to provide radio coverage to a specific geographical area using one or more cells to form a radio access network. The BS may support the operations of the cell(s), and each cell may be operable to provide services to at least one user equipment (UE) within its radio coverage. In order to reduce the inter-cell interference, a multiple transmission reception points (TRPs) architecture is supported in 5^{th} generation (5G) New Radio (NR) by allowing dynamic coordination between the multi-TRPs to provide joint scheduling and transmissions/receptions. As such, a UE, e.g., at the cell edge, may be served by multi-TRPs to improve its signal transmission/reception, which contributes to increased throughput.

However, there are some issues with the current framework of radio resource management (RRM) and mobility management in 5G NR. For example, the current synchronization signal block (SSB) design is node and beam aware, where each TRP transmits a respective SSB in a beam sweeping manner and the UE needs to perform beam sweeping for monitoring the SSB from each TRP. This SSB design not only causes increased UE power consumption (e.g., due to the beamforming operations), but also results in inefficient radio resource utilization (e.g., due to different SSBs having mostly the same content other than the physical broadcast channel (PBCH) part). Moreover, this SSB design may cause resource competition between layer-1 (L1) measurement and layer-3 (L3) measurement, since L1 measurement and L3 measurement may need to monitor different SSBs on different beams at the same time.

Accordingly, how to improve the framework of RRM and mobility management becomes an important topic for modern wireless communication systems. Therefore, there is a need to provide proper schemes to address the above-described issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to tiered RRM and mobility management. It is believed that the above-described issues would be avoided or otherwise alleviated by implementing one or more of the proposed schemes described herein.

In one aspect, a method may involve an apparatus (e.g., UE) receiving a first reference signal (RS) (e.g., a single frequency network (SFN) SSB) from a coverage area (e.g., SFN area), wherein the first RS comprises identification information of the coverage area and the coverage area comprises at least one of the following: one or more cells, and one or more network nodes controlled by a distributed unit (DU). The method may also involve the apparatus receiving a respective second RS from each of a plurality of network nodes (e.g., TRPs) within the coverage area, wherein the second RS each comprises identification information of a respective one of the plurality of network nodes. The method may further involve the apparatus performing a first measurement based on the first RS to determine to switch a service link from the coverage area to another coverage area and performing a second measurement based on the second RS to select one or more network nodes from a network node set to form the service link, wherein the network node set comprises at least the plurality of network nodes.

In one aspect, a method may involve a network node (e.g., TRP) within a coverage area transmitting a first RS (e.g., an SFN SSB) to an apparatus (e.g., UE), wherein the first RS comprises identification information of the coverage area. The method may also involve the network node transmitting a second RS (e.g., TRP RS) to the apparatus, wherein the second RS comprises identification information of the network node. The method may further involve the network node receiving a first measurement based on the first RS and a second measurement base on the second RS from the apparatus, wherein the first measurement is used to determine whether to switch a service link from the coverage area to another coverage area, the second measurement is used to select one or more network nodes from a network node set to form the service link, wherein the network node set comprises a plurality of network nodes. The method may further involve the network node performing a mobility management of the apparatus based on the first measurement, the second measurement, or a third measurement of an uplink (UL) signal from the apparatus.

It is noteworthy that, although description provided herein may be in the context of certain radio access technologies, networks and network topologies such as Long-Term Evolution (LTE), LTE-Advanced, LTE-Advanced Pro, 5^{th} Generation (5G), New Radio (NR), Internet-of-Things (IoT) and Narrow Band Internet of Things (NB-IoT), Industrial Internet of Things (IIoT), beyond 5G (B 5 G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of the current framework of RRM and mobility management in 5G NR.

FIG. 2 is a diagram depicting an example scenario of a tiered framework of RRM and mobility management in accordance with an implementation of the present disclosure.

FIG. 3 is a diagram depicting an example scenario of mobility management based on the tiered RRM framework in accordance with an implementation of the present disclosure.

FIG. 4 is a diagram depicting an example scenario of the tiered RRM for idle mode or power saving mode UE mobility in accordance with an implementation of the present disclosure.

FIG. 5 is a diagram depicting an example scenario of the tiered RRM for connected mode UE mobility in accordance with an implementation of the present disclosure.

FIG. 6 is a block diagram of an example communication system in accordance with an implementation of the present disclosure.

FIG. 7 is a flowchart of an example process in accordance with an implementation of the present disclosure.

FIG. 8 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to tiered RRM and mobility management. According to the present disclosure, a number of possible solutions may be implemented separately or jointly. That is, although these possible solutions may be described below separately, two or more of these possible solutions may be implemented in one combination or another.

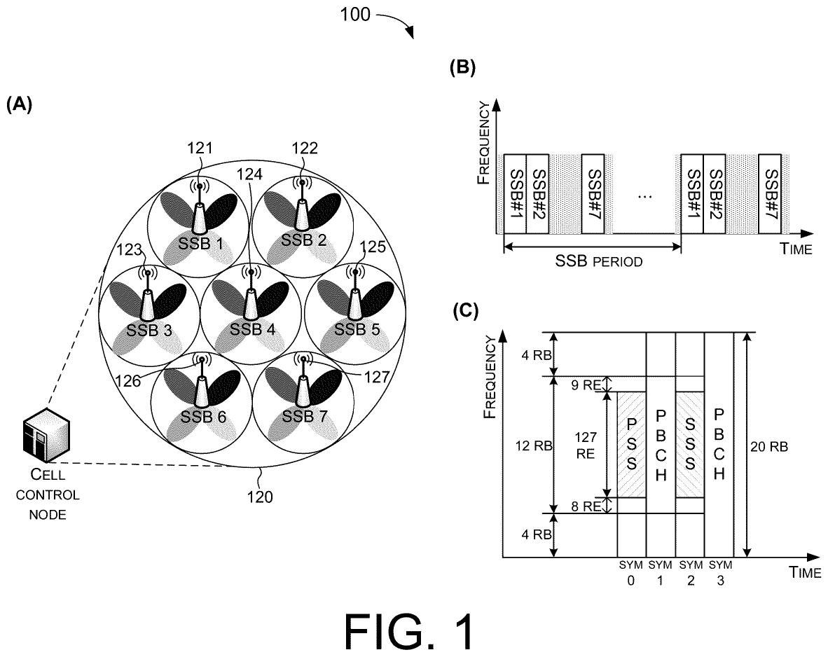

In 5G NR, the current framework of RRM and mobility management is based on the node and beam aware SSB design. FIG. 1 illustrates an example scenario 100 of the current framework of RRM and mobility management in 5G NR. Part (A) of FIG. 1 depicts multiple TRPs 121-127 within a cell 120, where each of the TRPs 121-127 transmits a respective SSB (denoted as SSB 1 to SSB 7) in a beam sweeping manner. Part (B) of FIG. 1 depicts the time and frequency resource allocation for the SSB transmissions of all TRPs within the cell 120, where the SSBs of different TRPs are transmitted in separate time domain resources within the SSB period. Part (C) of FIG. 1 depicts the SSB structure including a primary synchronization signal (PSS) and a secondary synchronization signal (SSS) for synchronization purpose, and a PBCH which contains the demodulation reference signal (DMRS) and data. For example, the PSS and/or the SSS may carry the cell identifier (ID) of the cell 120, and the PBCH may carry master information block (MIB) information and SSB index. For a UE (not shown) within the cell coverage, it may detect the following information from the SSB(s): (i) the cell ID for identifying the cell 120, (ii) the SSB index for identifying a TRP, (iii) the PBCH content other than the SSB index information, which has been transmitted repeatedly for multiple times, and it cannot be saved from transmission due to the beam sweeping architecture in frequency range 2 (FR2), and (iv) L1/L3 measurement RS which are combined as an SSB. However, as mentioned previously, this SSB design may not only cause increased UE power consumption (e.g., due to the beamforming operations), but also result in inefficient radio resource utilization (e.g., due to different SSBs having mostly the same content other than the PBCH part). Moreover, this SSB design may cause resource competition between L1 measurement and L3 measurement, since L1 measurement and L3 measurement may need to monitor different SSBs on different beams at the same time.

In view of the above, the present disclosure proposes a number of schemes pertaining to tiered RRM and mobility management, aiming to solve the above-described issues. According to the schemes of the present disclosure, a tiered framework of RRM and mobility management is provided to enhance overall system performance with respect to UE and NW operations in various operation modes, such as (radio resource control (RRC)) idle mode, power saving mode, and (RRC) connected mode.

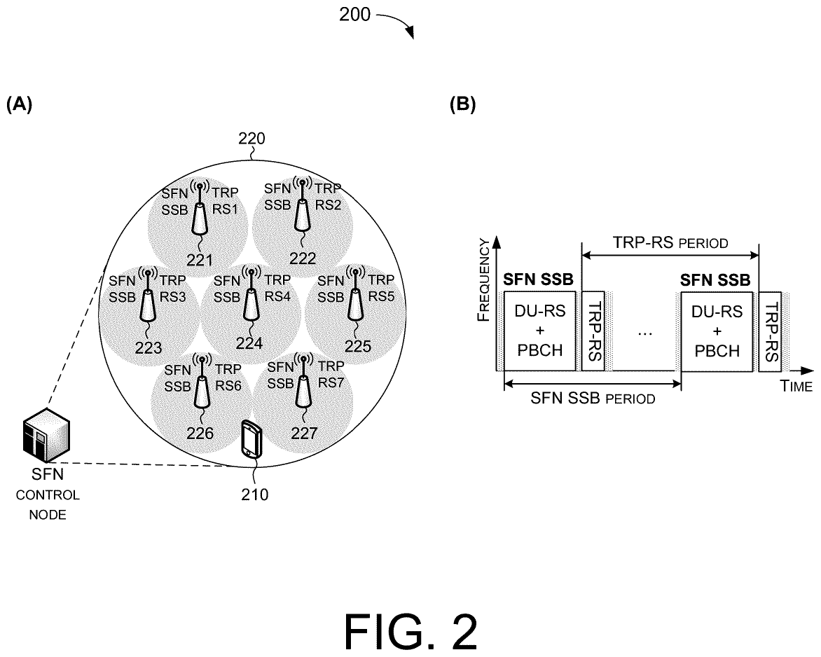

FIG. 2 illustrates an example scenario 200 of a tiered framework of RRM and mobility management in accordance with an implementation of the present disclosure. Part (A) of FIG. 2 depicts a communication environment involving a UE 210 in wireless communication with one or more of multiple TRPs (e.g., radio units (RUs)) 221-227 within an SFN area 220 which provides 1^{st}-tier RS, i.e., an SFN SSB, to the UE 210. That is, all of the TRPs 221-227 transmits the same 1^{st}-tier RS without beamforming or with beamforming that is UE transparent. Specifically, the SFN SSB includes identification information of the SFN area 220. In addition to the SFN SSB, each of the TRPs 221-227 also transmits a respective 2^{nd}-tier RS, i.e., a TRP RS. Specifically, the TRP RS includes identification information of a respective TRP (e.g., a TRP ID). That is, this TRP-specific signal may allow identification of a TRP, but may not allow identification of TRPs between different SFN areas. Part (B) of FIG. 2 depicts the time and frequency resource allocation for the SFN SSB and TRP RS transmissions of all TRPs within the SFN area 220, where the SFN SSB and the TRP RS are transmitted in separate time domain resources (e.g., the TRP RS is transmitted after the SFN SSB) to avoid resource competition between L1 measurement and L3 measurement. The UE 210 may perform (and report) a L3 measurement based on the SFN SSB to determine whether to switch a service link from the SFN area 220 to another SFN area, and a L1 measurement based on the TRP RS to select TRP(s) to form the service link, wherein the TRP(s) is/are selected from a TRP set which includes at least the TRPs 221-227. Accordingly, the SFN control node (e.g., a DU which provides scheduling and/or radio resource coordination capability) may perform a mobility management (e.g., inter-SFN mobility or intra-SFN inter-TRP mobility) of the UE 210 based on the L3 measurement, the L1 measurement, or the measurement of an UL signal (e.g., sounding reference signal (SRS), or physical random access channel (PRACH) signal) from the UE 210.

In some implementations, the SFN SSB may occupy a narrow bandwidth. For example, similar to the concept of synchronization signal and PBCH in 5G NR system, the SFN SSB may include a synchronization signal (or called DU-specific RS) (e.g., either both PSS and SSS, or simply one of PSS and SSS) and a PBCH.

In some implementations, the SFN SSB may be regularly transmitted. For example, the SFN SSB may be periodically or semi-periodically transmitted.

In some implementations, the TRP RS may occupy a narrow or wide bandwidth. For example, similar to the concept of synchronization signal in 5G NR system, the TRP RS may include a synchronization signal (e.g., SSS). The TRP RS may be a multi-port RS for spatial domain parameter estimation/acquisition. The TRS PRS may be configurable by, e.g., broadcast information (or system information) as a form of, e.g., a channel state information-reference signal (CSI-RS), such that the pattern, resource element occupation, and bandwidth of the TRP RS would be more flexible. Additionally, or optionally, the TRP RS may be associated with more than one occasion per TRP, with each occasion is corresponding to different spatial domain properties.

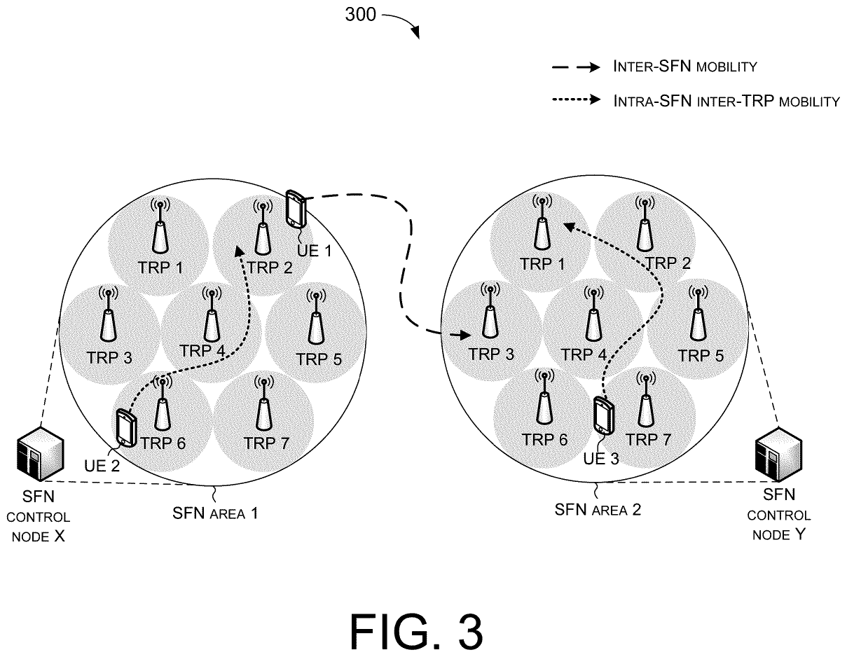

FIG. 3 illustrates an example scenario 300 of mobility management based on the tiered RRM framework in accordance with an implementation of the present disclosure. Scenario 300 depicts two types of UE's mobility, including inter-SFN mobility and intra-SFN inter-TRP mobility, in the proposed tiered framework of RRM and mobility management. As shown in FIG. 3, UE 1 undergoes an inter-SFN mobility from SFN area 1 to SFN area 2, and, more particularly, from TRP 2 of SFN area 1 to TRP 3 of SFN area 2. In addition, UE 2 undergoes an intra-SFN inter-TRP mobility within SFN area 1 (i.e., from TRP 6 of SFN area 1 to TRP 2 of SFN area 1), while UE 3 undergoes an intra-SFN inter-TRP mobility within SFN area 2 (i.e., from TRP 6 of SFN area 2 to TRP 6 of SFN area 2).

In some implementations, the inter-SFN mobility for idle mode or power saving mode UE may be based on the UE's measurement of the 1^{st}-tier signal (i.e., the SFN SSB). Alternatively, the inter-SFN mobility for connected mode UE may be based on the UE's measurement of the 1^{st}-tier signal (i.e., the SFN SSB) and optionally the 2^{nd}-tier signal (i.e., the TRP RS).

In some implementations, the intra-SFN inter-TRP mobility may be based on the UE's measurement of the 2^{nd}-tier signal (i.e., the TRP RS) or based on the NW's measurement of the UE's UL signal (e.g., SRS/PRACH signal). For the intra-frequency case, the intra-SFN inter-TRP mobility may be based on TRP RS (DL-based) or SRS/PRACH (UL based). For the inter-frequency case, the intra-SFN inter-TRP mobility may be based on TRP RS (DL-based, need measurement gap) (e.g., based on 1 port of TRP RS if it is a multi-port signal) or PRACH (UL based).

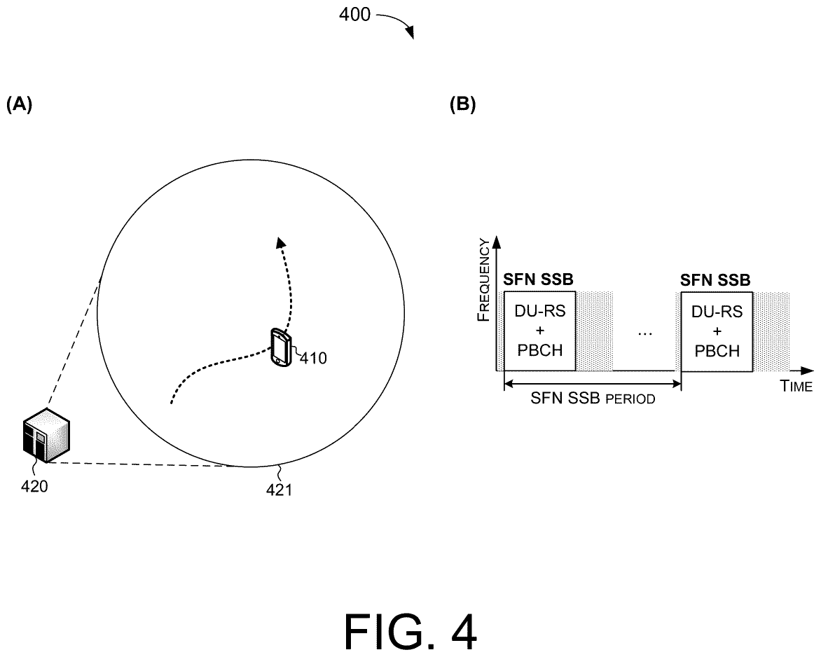

FIG. 4 illustrates an example scenario 400 of the tiered RRM for idle mode or power saving mode UE mobility in accordance with an implementation of the present disclosure. Part (A) of FIG. 4 depicts a UE 410 in wireless communication with an SFN control node 420 (e.g., a DU or a cell), where the UE 410 is operating in the idle mode or power saving mode and moves within the SFN area 421. It is noteworthy that the TRPs within the SFN area 421 are not shown because they are invisible or transparent to the UE 410 since the UE 410 only needs to monitor the SFN SSB in the idle mode or power saving mode and all TRPs within the SFN area 421 transmit the same SFN SSB that contains information allowing identification of a cell but not a TRP. Part (B) of FIG. 4 depicts the monitoring operation of the UE 410, which focuses on SFN SSB only, such that the UE power consumption may be reduced. The SFN SSB may include: (i) DU-RS consisting of PSS and/or SSS, which is/are generated as a small number of sequence due to large cell coverage assumption; and (ii) PBCH, which includes minimum system information (SI). In one example, the SFN SSB may be transmitted without beam sweeping in high frequency band (e.g., FR2 or FR3), and the array gain may be compensated by long DU-RS+PBCH transmission. When operating in the idle mode or power saving mode, the UE 410 may perform operations, including (L3) measurement of the SFN SSB, initial access to one TRP using a common PRACH pool (and the TRP may wake up during initial access), reception of essential SIBs that the PBCH points to, or paging monitoring based on a paging configuration common in the SFN area 421.

In some implementations, the tiered RRM in scenario 400 may also be applied to an enhanced mobile broadband (eMBB) idle mode UE, a reduced capability (ReCap) UE, or an NB IoT UE.

In some implementations, the SFN SSB may be transmitted with beamforming that is UE transparent (e.g., using small vertical subarray per TXRU as in low FR1 band, or using TRP-specific beam with TRP coverage in FR2 or FR3). For example, the subarray size may be selected to be big enough so that directly applying discrete Fourier transform (DFT) beamformer provides too small angular coverage. In order to utilize Tx power from power amplifiers linked to all antenna elements in a subarray, one embodiment is to specifically design a beamformer(s) with cell-wide angular coverage for the subarray. This way, cell-wide angular coverage and the full Tx power capability from the power amplifiers of subarray antenna elements can be achieved.

In some implementations, SFN-specific SI, such as MIB, and essential SIB(s), may be provided for initial access, e.g., with UE-transparent beamforming from the TRP with cell-wise coverage. Optionally, more than one port (e.g., 2 ports) may be used for, e.g., space frequency block code (SFBC) for diversity gain. The transmission length for the SI, e.g., PBCH/MIB, may be longer than connected mode data channel symbol length in order to compensate for BS-side array gain. The TRP RS configuration and/or RACH configuration may be pre-defined or provided in the SFN-specific (broadcast) information.

In some implementations, the paging configuration may be common in an SFN area. For example, the same paging configuration may be transmitted per TRP by cell-specific beam.

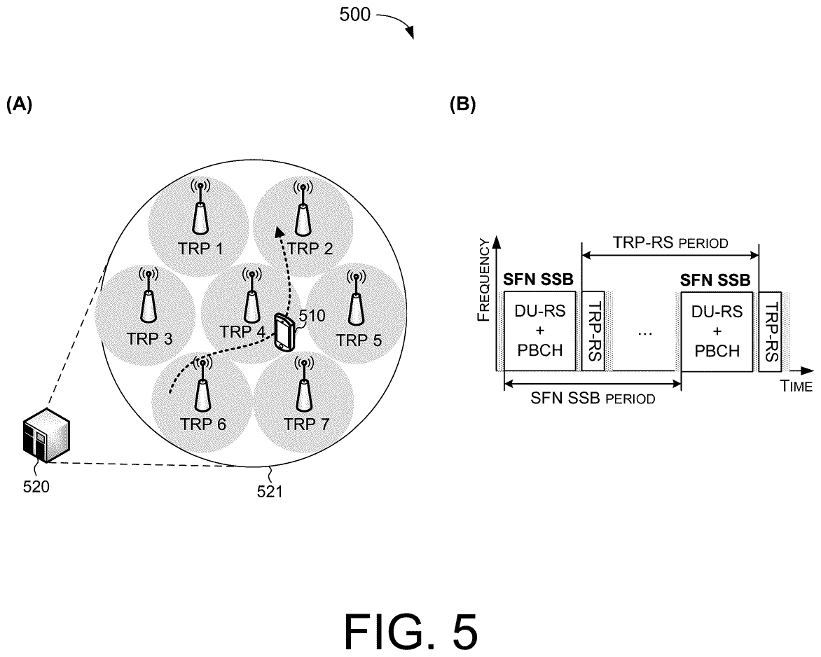

FIG. 5 illustrates an example scenario 500 of the tiered RRM for connected mode UE mobility in accordance with an implementation of the present disclosure. Part (A) of FIG. 5 depicts a UE 510 in wireless communication with multiple TRSs (denoted as TRP 1-7) controlled by an SFN control node 520 (e.g., a DU), where the UE 510 is operating in the connected mode and moves between the TRPs in the SFN area 521. It is noteworthy that the TRPs within the SFN area 521 are shown because they are visible to the UE 510 since the UE 510 needs to monitor both the SFN SSB and the TRP RS in the connected mode and the TRP RS contains information allows identification of a TRP. Part (B) of FIG. 5 depicts the monitoring operation of the UE 510, which focuses on both the SFN SSB and the TRP-RS. The TRP-specific ID may be determined based on sequence detection. Specifically, the TRP RS is time-division multiplexed (TDMed) with the SFN SSB, i.e., the SFN SSB and the TRP RS are not overlapped in the time domain, such that no resource competition between L1 measurement and L3 measurement is occurred. The TRP RSs of different TRPs are code-division multiplexed (CDMed) with each other. When operating in the connected mode, the UE 510 may perform operations, including (L1) measurement of the TRP RS (e.g., multi-port TRP-RS for initial spatial domain parameter acquisition), mobility anchored on TRP-RS and TRP set selection (e.g., to facilitate distributed multiple-input multiple-output (MIMO) operation), and beam acquisition/refinement during the RACH procedure.

In some implementations, the tiered RRM in scenario 500 may also be applied to an eMBB connected mode UE. For a UE in connected mode, in order to maintain the individual service links to the selected TRPs, it is necessary to continuously perform downlink (DL) synchronization and uplink (UL) synchronization using the TRP-reference signals (TRP-RS) transmitted by each TRP. However, the propagation delay between different TRPs and the UE varies, and there may also be clock errors among different TRPs. Therefore, we need to designate one TRP as the primary reference point, which we refer to as the primary TRP. The primary TRP may need to be known on both UE side and network side, and the UE 510 may refer to the primary TRP to determine its own transmission power and transmission timing. Data to the UE 510 may be transmitted simultaneously by a set of TRPs within the SFN area 521, and the TRP set may be selected by the UE 510 and confirmed by the network.

### Illustrative Implementations

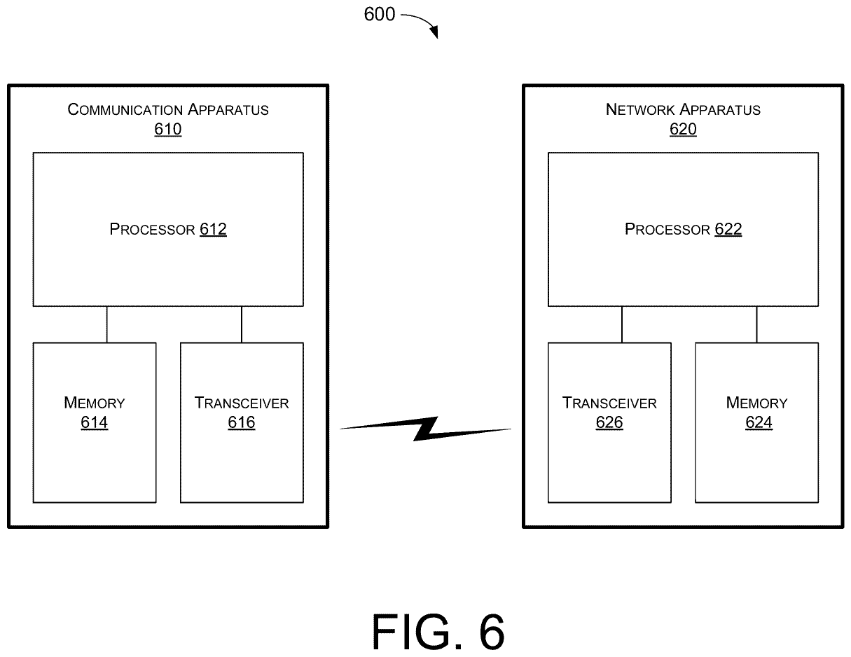

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to tiered RRM and mobility management, including scenarios/schemes described above as well as processes 700 and 800 described below.

Communication apparatus 610 may be a part of an electronic apparatus, which may be a UE (e.g., an eMBB UE) such as a portable or mobile apparatus, a wearable apparatus, a wireless communication apparatus or a computing apparatus. For instance, communication apparatus 610 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 610 may also be a part of a machine type apparatus, which may be a ReCap UE, an IoT, NB-IoT, eMTC, IIoT UE such as an immobile or a stationary apparatus, a home apparatus, a roadside unit (RSU), a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of an electronic apparatus, which may be a network node such as a TRP, an RU, a small cell, a router or a gateway of a wireless network. For instance, network apparatus 620 may be implemented in a TRP/RU in a 4G/5G/6G, IoT, NB-IoT or IIoT network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks, including tiered RRM and mobility management, in a device (e.g., as represented by communication apparatus 610) and a network node (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, transceiver 616 may be capable of wirelessly communicating with different types of UEs and/or wireless networks of different radio access technologies (RATs), such as 4G/5G/B5G/6G. In some implementations, transceiver 616 may be equipped with a plurality of antenna ports (not shown) such as, for example, four antenna ports. That is, transceiver 616 may be equipped with multiple transmit antennas and multiple receive antennas for MIMO wireless communications. In some implementations, network apparatus 620 may also include a transceiver 626 coupled to processor 622. Transceiver 626 may include a transceiver capable of wirelessly transmitting and receiving data. In some implementations, transceiver 626 may be capable of wirelessly communicating with different types of UEs of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, communication apparatus 610 may further include a memory 614 coupled to processor 612 and capable of being accessed by processor 612 and storing data therein. In some implementations, network apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 610 and network apparatus 620 may be a communication entity capable of communicating with each other using various proposed schemes in accordance with the present disclosure. For illustrative purposes and without limitation, a description of capabilities of communication apparatus 610, as a UE, and network apparatus 620, as a network node (e.g., TRP or RU), is provided below with processes 700 and 800.

### Illustrative Processes

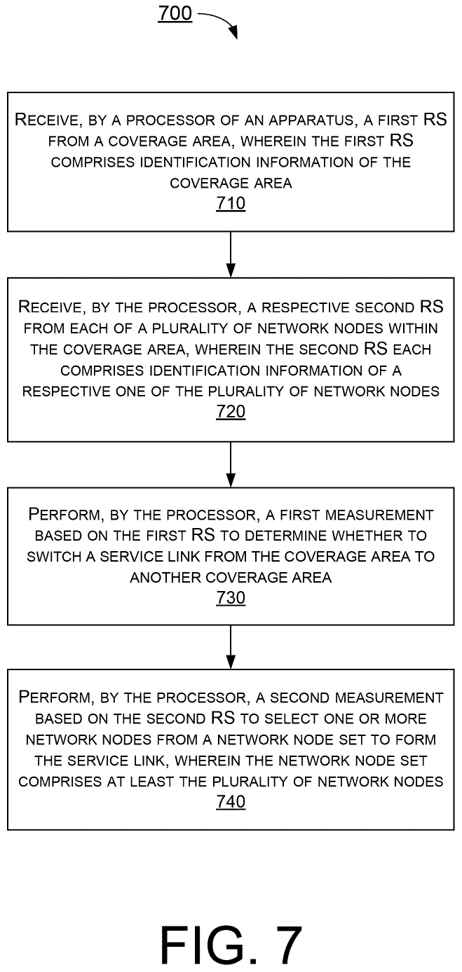

FIG. 7 illustrates an example process 700 in accordance with an implementation of the present disclosure. Process 700 may be an example implementation of above scenarios/schemes, whether partially or completely, with respect to tiered RRM and mobility management. Process 700 may represent an aspect of implementation of features of communication apparatus 610. Process 700 may include one or more operations, actions, or functions as illustrated by one or more of blocks 710 to 740. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At 710, process 700 may involve processor 612 of communication apparatus 610 receiving, via transceiver 616, a first RS (e.g., SFN SSB) from a coverage area, wherein the first RS comprises identification information of the coverage area. Process 700 may proceed from 710 to 720.

At 720, process 700 may involve processor 612 receiving, via transceiver 616, a respective second RS (e.g., TRP RS) from each of a plurality of network nodes (e.g., TRPs) within the coverage area, wherein the second RS each comprises identification information of a respective one of the plurality of network nodes. Process 700 may proceed from 720 to 730.

At 730, process 700 may involve processor 612 performing a first measurement based on the first RS to determine to switch a service link from the coverage area to another coverage area. Process 700 may proceed from 730 to 740.

At 740, process 700 may involve processor 612 performing a second measurement based on the second RS to select one or more network nodes from a network node set to form the service link, wherein the network node set comprises at least the plurality of network nodes.

In some implementations, the overage area may include at least one of the following: one or more cells; and one or more network nodes controlled by a DU.

In some implementations, the first RS may include a PBCH and at least one of a PSS and an SSS, or the first RS may not include identification information of any of the plurality of network nodes, or the first RS may be received periodically or semi-periodically.

In some implementations, the second RS may have a bandwidth smaller than that of a TRP-RS, or the second RS may be associated with one or more occasions corresponding to different spatial domain properties.

In some implementations, the receiving of the first RS may be performed in an event that communication apparatus 610 is operating in an idle mode or a power saving mode, or in an event that communication apparatus 610 is an eMBB UE operating in the idle mode, a ReCap UE, or an NB IoT UE. Alternatively, the receiving of the first RS and the receiving of the second RS may be performed in an event that communication apparatus 610 is operating in a connected mode, or in an event that communication apparatus 610 is an eMBB UE operating in the connected mode.

In some implementations, process 700 may further involve processor 612 performing, via transceiver 616, an initial access to one of the network nodes using a PRACH pool common in the coverage area.

In some implementations, the PRACH pool may be predefined, or configured via a PBCH of the first RS or via a SIB indicated by the PBCH.

In some implementations, a sub-carrier spacing (SCS) of the first RS may be smaller than or equal to that of the second RS, or a transmission bandwidth of the first RS may be smaller than or equal to that of the second RS, or a transmission symbol timing of the first RS may be longer than or equal to that of the second RS.

In some implementations, the second RSs from different network nodes may be received in a same time-frequency resource, and the second RSs may be CDMed with each other, or the second RS may be received after the first RS, or the second RS may be predefined, or configured via a PBCH of the first RS or via a SIB indicated by the PBCH.

In some implementations, process 700 may further involve processor 612 receiving, via transceiver 616, one or more same SIBs indicated by the first RS from the network nodes. Alternatively, process 700 may further involve processor 612 receiving, via transceiver 616, a same paging message from the network nodes based on a paging configuration common in the coverage area.

In some implementations, the coverage area may be corresponding to a DU or a cell, and each of the network nodes may be a TRP or an RU.

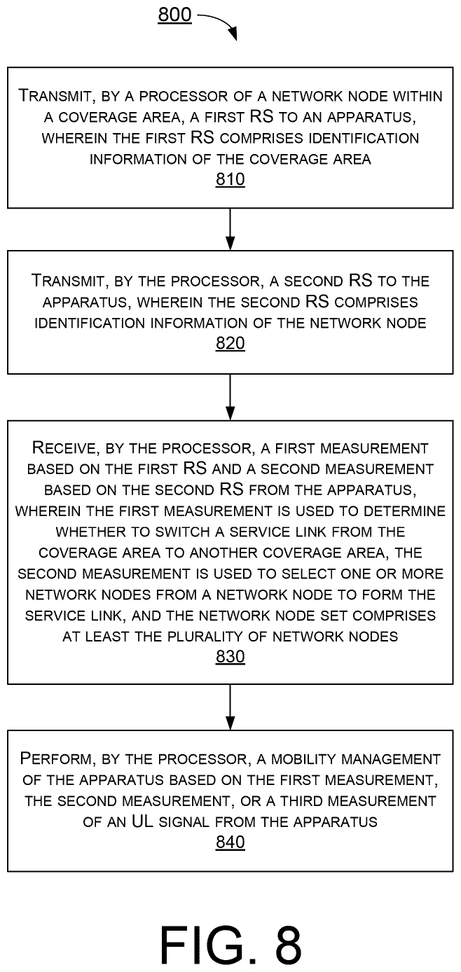

FIG. 8 illustrates an example process 800 in accordance with an implementation of the present disclosure. Process 800 may be an example implementation of above scenarios/schemes, whether partially or completely, with respect to tiered RRM and mobility management. Process 800 may represent an aspect of implementation of features of network apparatus 620. Process 800 may include one or more operations, actions, or functions as illustrated by one or more of blocks 810 to 840. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by network apparatus 620 or any suitable network node. Solely for illustrative purposes and without limitation, process 800 is described below in the context of network apparatus 620. Process 800 may begin at block 810.

At 810, process 800 may involve processor 622 of network apparatus 620 transmitting, via transceiver 626, a first RS (e.g., SFN SSB) to communication apparatus 610, wherein the first RS comprises identification information of a coverage area. Process 800 may proceed from 810 to 820.

At 820, process 800 may involve processor 622 transmitting, via transceiver 626, a second RS (e.g., TRP RS) to communication apparatus 610, wherein the second RS comprises identification information of network apparatus 620. Process 800 may proceed from 820 to 830.

At 830, process 800 may involve processor 622 receiving, via transceiver 626, a first measurement based on the first RS and a second measurement based on the second RS from communication apparatus 610, wherein the first measurement is used to determine whether to switch a service link from the coverage area to another coverage area, the second measurement is used to select one or more network nodes from a network node set to form the service link, wherein the network node set comprises at least the plurality of network nodes. Process 800 may proceed from 830 to 840.

At 840, process 800 may involve processor 622 performing a mobility management of communication apparatus 610 based on the first measurement, the second measurement, or a third measurement of an UL signal from communication apparatus 610.

In some implementations, the overage area may include at least one of the following: one or more cells; and one or more network nodes controlled by a DU.

In some implementations, the first RS may include a PBCH and at least one of a PSS and an SSS, or the first RS may not include identification information of any of the plurality of network nodes, or the first RS may be received periodically or semi-periodically, or the first RS may be transmitted without beamforming or with beamforming that is transparent to communication apparatus 610.

In some implementations, the second RS may have a bandwidth smaller than that of a TRP-RS, or the second RS may be a multi-port RS, or the second RS may be associated with one or more occasions corresponding to different spatial domain properties.

In some implementations, the first RS may be received at communication apparatus 610 in an event that communication apparatus 610 is operating in an idle mode or a power saving mode, or in an event that communication apparatus 610 is an eMBB UE operating in the idle mode, a ReCap UE, or an NB IoT UE. Alternatively, the first RS and the second RS may be received at communication apparatus 610 in an event that communication apparatus 610 is operating in a connected mode, or in an event that communication apparatus 610 is an eMBB UE operating in the connected mode.

In some implementations, process 800 may further involve processor 622 receiving, via transceiver 626, an initial access from communication apparatus 610 using a PRACH pool common in the coverage area.

In some implementations, the PRACH pool may be predefined, or configured via a PBCH of the first RS or via a SIB indicated by the PBCH.

In some implementations, an SCS of the first RS may be smaller than or equal to that of the second RS, or a transmission bandwidth of the first RS may be smaller than or equal to that of the second RS, or a transmission symbol timing of the first RS may be longer than or equal to that of the second RS.

In some implementations, the second RSs from different network nodes may be received in a same time-frequency resource, and the second RSs may be CDMed with each other, or the second RS may be received after the first RS, or the second RS may be predefined, or configured via a PBCH of the first RS or via a SIB indicated by the PBCH.

In some implementations, process 800 may further involve processor 622 transmitting, via transceiver 626, one or more same SIBs indicated by the first RS to communication apparatus 610, wherein the SIBs may be the same as other SIBs transmitted by other network nodes within the coverage area. Alternatively, process 800 may further involve processor 622 transmitting, via transceiver 626, a same paging message to communication apparatus 610 based on a paging configuration common in the coverage area, wherein the paging message may be the same as paging messages transmitted by other network nodes within the coverage area.

In some implementations, the coverage area may be corresponding to a DU or a cell, and each of the network nodes may be a TRP or an RU.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a first reference signal (RS) from a coverage area, wherein the first RS comprises identification information of the coverage area;
receiving, by the processor, a respective second RS from each of a plurality of network nodes within the coverage area, wherein the second RS each comprises identification information of a respective one of the plurality of network nodes;
performing, by the processor, a first measurement based on the first RS to determine whether to switch a service link from the coverage area to another coverage area; and
performing, by the processor, a second measurement based on the second RS to select one or more network nodes from a network node set to form the service link, wherein the network node set comprises at least the plurality of network nodes.

2. The method of claim 1, wherein the coverage area comprises at least one of the following:
one or more cells; and
one or more network nodes controlled by a distributed unit (DU).

3. The method of claim 1, wherein:
the first RS comprises a physical broadcast channel (PBCH) and at least one of a primary synchronization signal (PSS) and a secondary synchronization signal (SSS);
the first RS does not comprise identification information of any of the plurality of network nodes; or
the first RS is received periodically or semi-periodically.

4. The method of claim 1, wherein:
the second RS has a bandwidth smaller than that of a transmission reception point (TRP) RS;
the second RS is a multi-port RS; or
the second RS is associated with one or more occasions corresponding to different spatial domain properties.

5. The method of claim 1, wherein:
the receiving of the first RS is performed in an event that the apparatus is operating in an idle mode or a power saving mode, or in an event that the apparatus is an enhanced mobile broadband (eMBB) user equipment (UE) operating in the idle mode, a reduced capability (ReCap) UE, or a narrowband (NB) Internet-of-things (IoT) UE; or
the receiving of the first RS and the receiving of the second RS are performed in an event that the apparatus is operating in a connected mode, or in an event that the apparatus is an eMBB UE operating in the connected mode.

6. The method of claim 1, further comprising:
performing, by the processor, an initial access to one of the network nodes using a physical random access channel (PRACH) pool common in the coverage area.

7. The method of claim 5, wherein the PRACH pool is predefined, or configured via a PBCH of the first RS or via a system information block (SIB) indicated by the PBCH.

8. The method of claim 1, wherein:
a sub-carrier spacing (SCS) of the first RS is smaller than or equal to that of the second RS;
a transmission bandwidth of the first RS is smaller than or equal to that of the second RS; or
a transmission symbol timing of the first RS is longer than or equal to that of the second RS.

9. The method of claim 1, wherein:
the second RSs from different network nodes are received in a same time-frequency resource, and the second RSs are code-division multiplexed (CDMed) with each other;
the second RS is received after the first RS; or
the second RS is predefined or configured via a PBCH of the first RS or via a SIB indicated by the PBCH.

10. The method of claim 1, further comprising:
receiving, by the processor, one or more same SIBs indicated by the first RS from the network nodes; or
receiving, by the processor, a same paging message from the network nodes based on a paging configuration common in the coverage area.

11. A method, comprising:
transmitting, by a processor of a network node within a coverage area, a first reference signal (RS) to an apparatus, wherein the first RS comprises identification information of the coverage area;
transmitting, by the processor, a second RS to the apparatus, wherein the second RS comprises identification information of the network node;
receiving, by the processor, a first measurement based on the first RS and a second measurement based on the second RS from the apparatus, wherein the first measurement is used to determine whether to switch a service link from the coverage area to another coverage area, the second measurement is used to select one or more network nodes from a network node set to form the service link, and the network node set comprises a plurality of network nodes; and
performing, by the processor, a mobility management of the apparatus based on the first measurement, the second measurement, or a third measurement of an uplink (UL) signal from the apparatus.

12. The method of claim 11, wherein the coverage area comprises at least one of the following:
one or more cells; and
one or more network nodes controlled by a distributed unit (DU).

13. The method of claim 11, wherein:
the first RS comprises a physical broadcast channel (PBCH) and at least one of a primary synchronization signal (PSS) and a secondary synchronization signal (SSS);
the first RS does not comprise identification information of any of the plurality of network nodes;
the first RS is transmitted periodically or semi-periodically; or
the first RS is transmitted without beamforming or with beamforming that is transparent to the apparatus.

14. The method of claim 11, wherein:
the second RS has a bandwidth smaller than that of a transmission reception point (TRP) RS;
the second RS is a multi-port RS; or
the second RS is associated with one or more occasions corresponding to different spatial domain properties.

15. The method of claim 11, wherein:
the first RS is received at the apparatus in an event that the apparatus is operating in an idle mode or a power saving mode, or in an event that the apparatus is an enhanced mobile broadband (eMBB) user equipment (UE) operating in the idle mode, a reduced capability (ReCap) UE, or a narrowband (NB) Internet-of-things (IoT) UE; or
the first RS and the second RS are received at the apparatus in an event that the apparatus is operating in a connected mode, or in an event that the apparatus is an eMBB UE operating in the connected mode.

16. The method of claim 11, further comprising:
receiving, by the processor, an initial access from the apparatus using a physical random access channel (PRACH) pool common in the coverage area.

17. The method of claim 15, wherein the PRACH pool is predefined, or configured to the apparatus via a PBCH of the first RS or via a system information block (SIB) indicated by the PBCH.

18. The method of claim 11, wherein:
a sub-carrier spacing (SCS) of the first RS is smaller than or equal to that of the second RS;
a transmission bandwidth of the first RS is smaller than or equal to that of the second RS; or
a transmission symbol timing of the first RS is longer than or equal to that of the second RS.

19. The method of claim 11, wherein:
the second RSs from different network nodes are received in a same time-frequency resource, and the second RSs are code-division multiplexed (CDMed) with each other;
the second RS is received after the first RS; or
the second RS is predefined, or configured via a PBCH of the first RS or via a SIB indicated by the PBCH.

20. The method of claim 11, further comprising:
transmitting, by the processor, one or more SIBs indicated by the first RS to the apparatus, wherein the SIBs are the same as other SIBs transmitted by other network nodes within the coverage area; or
transmitting, by the processor, a paging message to the apparatus based on a paging configuration common in the coverage area, wherein the paging message is the same as other paging messages transmitted by other network nodes within the coverage area.
